(19) United States
(12) Patent Application Publication
(10) Pub. No.: US 2022/0161395 A1
(43) Pub. Date: May 26, 2022

(54) TOOL JAW WIDTH ADJUSTMENT STRUCTURE

(71) Applicant: Ien U Wang, Taichung City (TW)

(72) Inventor: Ien U Wang, Taichung City (TW)

(21) Appl. No.: 17/667,368

(22) Filed: Feb. 8, 2022

Related U.S. Application Data
(63) Continuation-in-part of application No. 16/877,890, filed on May 19, 2020.

(51) Int. Cl. B25B 7/10

(52) U.S. Cl. CPC B25B 7/10

(57) ABSTRACT

A tool jaw width adjustment structure includes a first plier body and a second plier body that cross each other. The first plier body has an elongated hole. One side of the elongated hole is provided with a toothed portion. The second plier body is provided with a cylindrical shaft inserting through the elongated hole. A distal end of the cylindrical shaft is provided with a side plate extending beyond one side of the toothed portion. A periphery of the cylindrical shaft is provided with a toothed block that is always meshed with the toothed portion. When the second plier body is pivotally opened relative to the first plier body, the toothed block is kept in mesh with the toothed portion, and the cylindrical shaft is driven to roll in the elongated hole from a first position to a second position, so as to increase the width of the jaw.

### REFERENCE TO RELATED APPLICATIONS

This Application is being filed as a Continuation-in-Part of application Ser. No. 16/877,890, filed May 19, 2020, currently pending.

### FIELD OF THE INVENTION

The present invention relates to hand tools, and more particularly to a pair of pliers.

### BACKGROUND OF THE INVENTION

Pliers are a labor-saving tool using the principle of leverage. In order to improve the labor-saving effect, the effort arm of the pliers should be long and the resistance arm should be short. However, the short resistance arm will cause the situation that the jaws cannot be opened enough to grip the workpiece properly. On the other hand, if the jaws are designed to have a predetermined width, the effort arm (namely, the plier handles) will be longer, and the distance between the distal ends of the plier handles will be greater. As a result, it is difficult to operate the pliers with one hand. Taiwan Utility Model Publication No. M412843 and U.S. Pat. No. 1,236,138A respectively disclose a pair of pliers. A main plier body is provided with a window. The window has two wide ends and a narrow middle. Another movable plier body has a pivot inserting into the window to be connected to the main plier body. When the two plier bodies are relatively opened, the pivot will be moved in the window to increase the width of the jaws.

However, in the above-mentioned conventional structure, the pivot is formed into an elongated flat shape, and it is oriented toward a specific orientation to pass through the passage in the narrow middle of the window. Thus, it is necessary to adjust the position of the pivot before opening the pliers for the jaws to be opened wide. The operation is complicated. On the other hand, the user needs to perform the above-mentioned operation with both hands. The operation cannot be completed with one hand, leading to inconvenience in use.

U.S. Pat. No. 4,893,530 discloses a pair of pliers. A main plier body is formed with a straight groove, and another movable plier body is provided with a shaft that passes through the straight groove and is connected to the main plier body. One side of the straight groove is provided with a toothed portion, and one side of the shaft is provided with a toothed block. When the two plier bodies are relatively opened, the toothed block is separated from the toothed portion, so that the shaft can slide in the straight groove, thereby moving the movable plier body to adjust the width of the jaws. However, it is necessary to operate this conventional device with both hands.

### SUMMARY OF THE INVENTION

The primary object of the present invention is to provide a tool jaw width adjustment structure. When the tool is opened, the shaft is synchronously moved to expand the jaw of the tool. The present invention has the effects of simple structure and convenient operation.

In order to achieve the above object, the present invention provides a tool jaw width adjustment structure, comprising:

a first plier body, having an elongated hole, one side of the elongated hole being provided with a toothed portion extending along its length direction, one end of the first plier body having a first working section;

a second plier body crossing the first plier body, one end of the second plier body having a second working section, a jaw being defined between the first working section and the second working section; the second plier body being connected with a cylindrical shaft inserting through the elongated hole, a distal end of the cylindrical shaft being provided with a side plate extending beyond one side of the toothed portion, a periphery of the cylindrical shaft being provided with a toothed block that is always meshed with the toothed portion;

wherein when the second plier body is pivotally opened relative to the first plier body, the toothed block is kept in mesh with the toothed portion, and the cylindrical shaft is driven to roll in the elongated hole from a first position to a second position, so as to increase a width of the jaw.

Preferably, the second plier body has a through hole. One side of the through hole is provided with a retaining nut. One end of the cylindrical shaft is inserted through the through hole to be locked to the retaining nut.

In one embodiment, one side of the first working section, facing the second working section, and one side of the second working section, facing the first working section, are each in the form of a smooth side.

In another embodiment, one side of the first working section, facing the second working section, and one side of the second working section, facing the first working section, are each provided with a toothed structure.

### BRIEF DESCRIPTION OF THE DRAWINGS

FIG. 1 is an exploded view according to a first embodiment of the present invention;

FIG. 2 is a partial schematic view according to the first embodiment of the present invention;

FIG. 3 and FIG. 4 are schematic views according to the first embodiment of the present invention when in use; and

FIG. 5 and FIG. 6 are schematic views according to a second embodiment of the present invention when in use.

### DETAILED DESCRIPTION OF THE PREFERRED EMBODIMENTS

Embodiments of the present invention will now be described, by way of example only, with reference to the accompanying drawings.

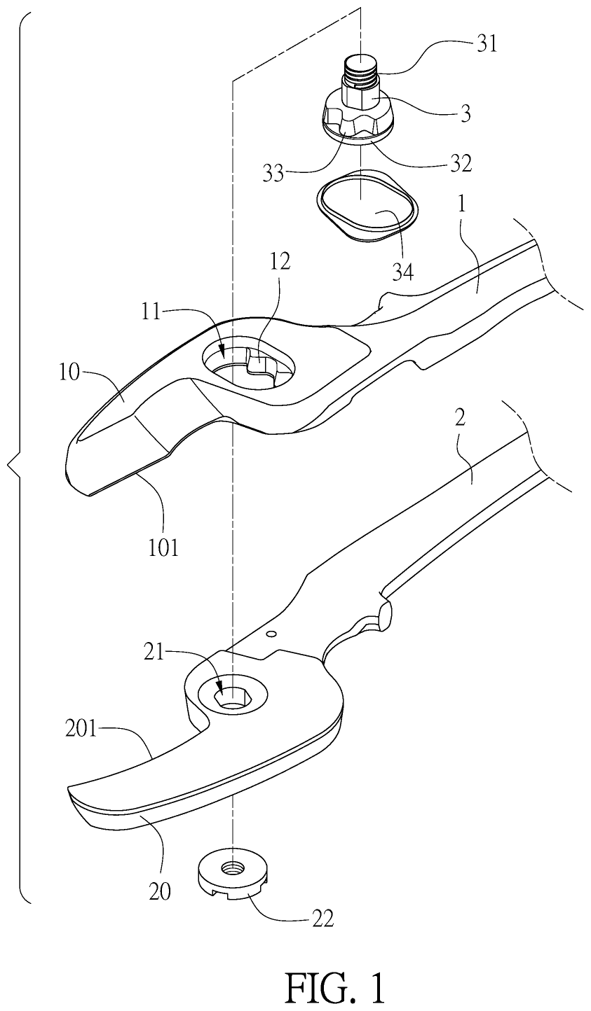

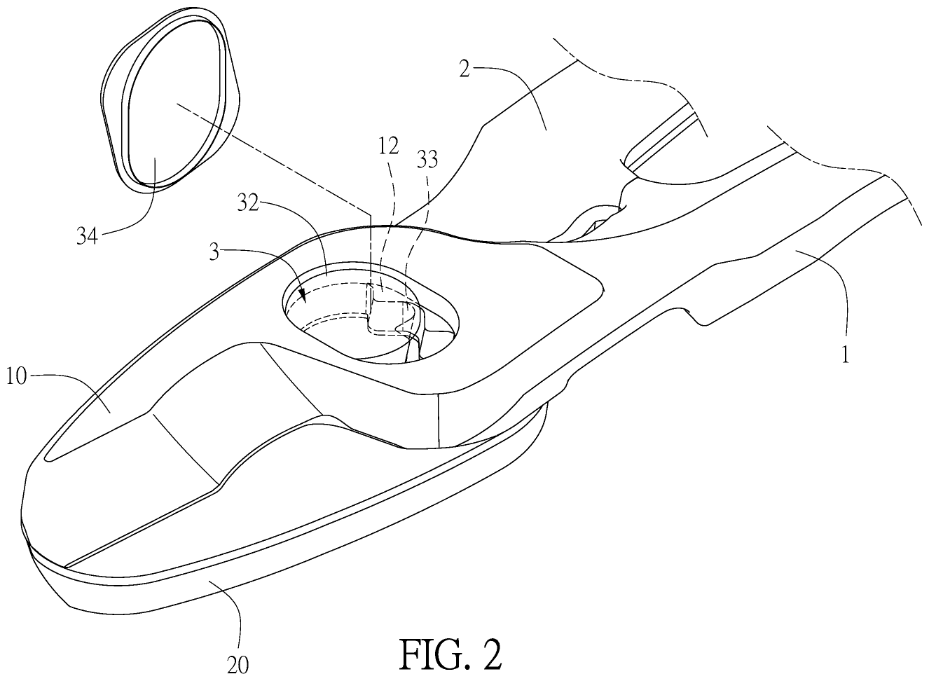

Referring to FIG. 1 and FIG. 2, a tool jaw width adjustment structure according to a first embodiment of the present invention comprises a first plier body 1 and a second plier body 2 that cross each other. One end of the first plier body 1 has a first working section 10. One end of the second plier body 2 has a second working section 20. A jaw 4 is defined between the first working section 10 and the second working section 20. In this embodiment, one side 101 of the first working section 10, facing the second working section 20, and one side 201 of the second working section 20, facing the first working section 10, are each in the form of a smooth side.

The first plier body 1 has an elongated hole 11. One side of the elongated hole 11 is provided with a toothed portion 12 extending along its length direction. The toothed portion 12 is integrally formed with the first plier body 1 by forging and pressing, so as to achieve the purpose of high strength.

The second plier body 2 has a through hole 21 corresponding in position to the elongated hole 11. One side of the through hole 21 is provided with a retaining nut 22. A shaft 3 is provided with a threaded section 31 at one end thereof. The threaded section 31 passes through the elongated hole 11 and the through hole 21 to be locked to the retaining nut 22, so as to be fixed to the second plier body 2. In other embodiments, the shaft 3 may be connected to the second plier body 2 by riveting.

The shaft 3 is inserted through the elongated hole 11, and is provided with a side plate 32 at its distal end. The side plate 32 extends beyond one side of the toothed portion 12, so that the first plier body 1 is positioned on the second plier body 2 because the toothed portion 12 is blocked by the side plate 32. A cover plate 34 for shielding the side plate 32 is provided on one side of the first plier body 1 to prevent debris from entering the elongated hole 11.

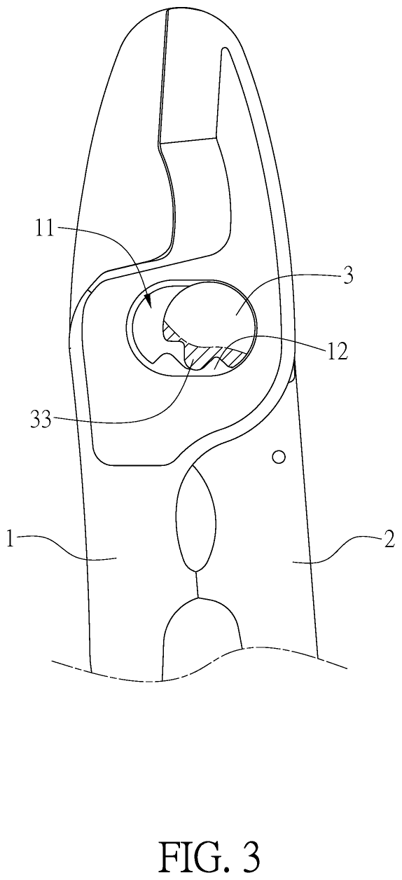

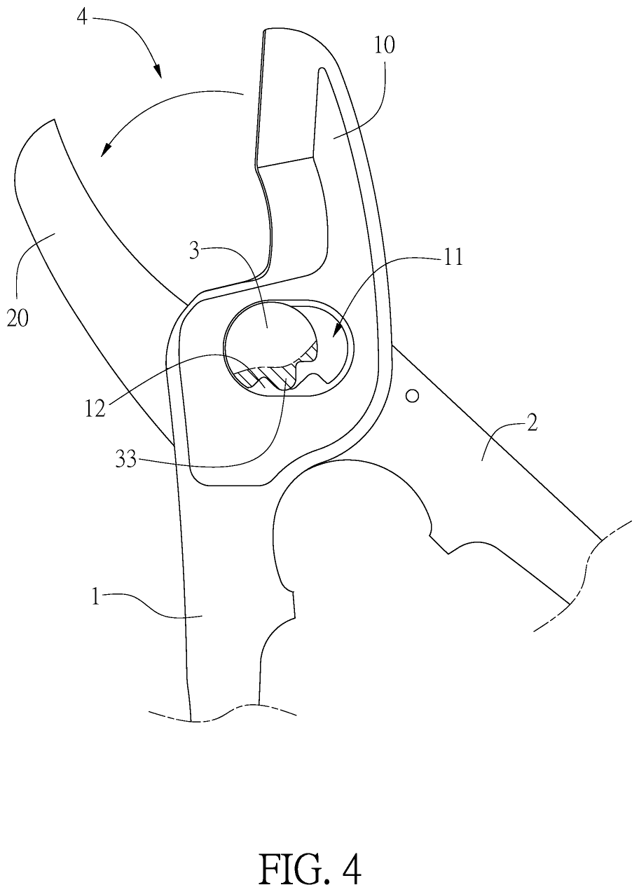

The shaft 3 is in a cylindrical shape. A portion of the periphery of the shaft 3 is provided with a toothed block 33 meshing with the toothed portion 12. The toothed block 33 and the toothed portion 12 may have straight teeth or oblique teeth to mesh with each other. When the second plier body 2 is pivotally opened relative to the first plier body 1, the shaft 3 is rotated along with the second plier body 2 and the toothed block 33 is always meshed with the toothed portion 12, so that the shaft 3 is rolled in the elongated hole 11 from a first position, as shown in FIG. 3, to a second position, as shown in FIG. 4. When the two plier bodies are opened, the displacement of the shaft 3 in the elongated hole 11 increases the width of the jaw 4. This is beneficial for gripping larger workpieces.

With the above structure, when the two plier bodies of the present invention are opened, the shaft 3 will move in the elongated hole 11 synchronously with the pivoting movement of the second plier boy 2. There is no need for the user to manually adjust the position of the shaft 3. Thereby, it is convenient for the user to hold the pliers with one hand to open the two plier bodies. The width between the jaws can automatically increase, thereby achieving the effects of easy operation and convenient use.

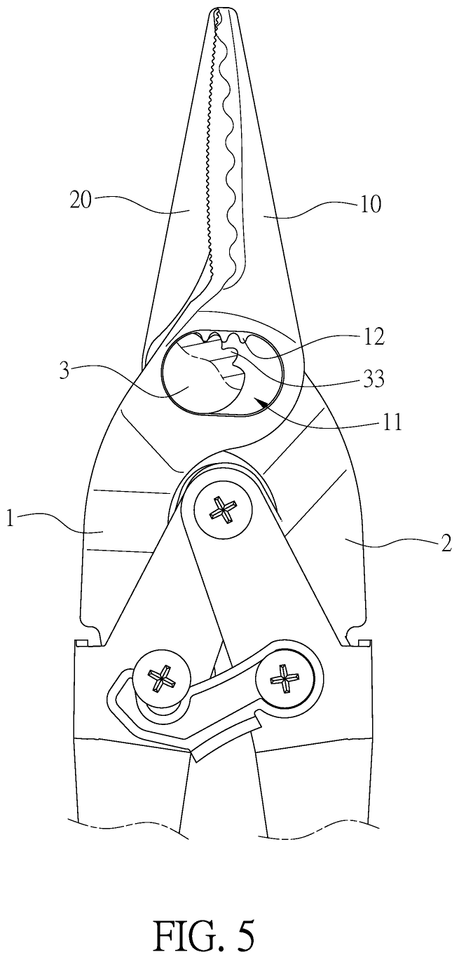

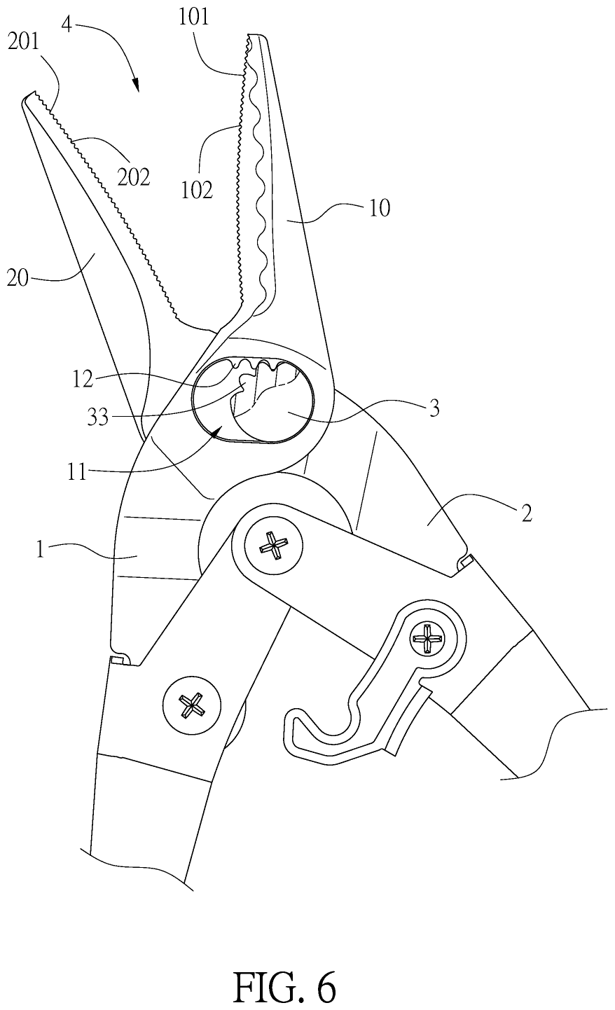

FIG. 5 and FIG. 6 illustrate a second embodiment of the present invention. The structure of the second embodiment is based on the structure of the first embodiment. The difference between the two embodiments is the shapes of the first working section 10 and the second working section 20. In this embodiment, one side 101 of the first working section 10, facing the second working section 20, and one side 201 of the second working section 20, facing the first working section 10, are each provided with a toothed structure 102, 202 for gripping a workpiece more stably.

What is claimed is:

1. A tool jaw width adjustment structure, comprising:
a first plier body, having an elongated hole, one side of the elongated hole being provided with a toothed portion extending along its length direction, one end of the first plier body having a first working section;
a second plier body crossing the first plier body, one end of the second plier body having a second working section, a jaw being defined between the first working section and the second working section; the second plier body being connected with a cylindrical shaft inserting through the elongated hole, a distal end of the cylindrical shaft being provided with a side plate extending beyond one side of the toothed portion, a periphery of the cylindrical shaft being provided with a toothed block that is always meshed with the toothed portion;
wherein when the second plier body is pivotally opened relative to the first plier body, the toothed block is kept in mesh with the toothed portion, and the cylindrical shaft is driven to roll from a first position to a second position in the elongated hole, so as to increase a width of the jaw.

2. The tool jaw width adjustment structure as claimed in claim 1, wherein the toothed block and the toothed portion have straight teeth or oblique teeth to mesh with each other.

3. The tool jaw width adjustment structure as claimed in claim 1, wherein the second plier body has a through hole, one side of the through hole is provided with a retaining nut, and one end of the cylindrical shaft is inserted through the through hole to be locked to the retaining nut.

4. The tool jaw width adjustment structure as claimed in claim 1, wherein one side of the first working section, facing the second working section, and one side of the second working section, facing the first working section, are each in the form of a smooth side.

5. The tool jaw width adjustment structure as claimed in claim 1, wherein one side of the first working section, facing the second working section, and one side of the second working section, facing the first working section, are each provided with a toothed structure.
